(19) United States
(12) Patent Application Publication
(10) Pub. No.: US 2015/0074016 A1
(43) Pub. Date: Mar. 12, 2015

(54) Visualized Market Monitoring

(71) Applicant: David Martin, Natick, MA (US)

(72) Inventor: David Martin, Natick, MA (US)

(73) Assignee: FMR LLC, Boston, MA (US)

(21) Appl. No.: 14/023,144

(22) Filed: Sep. 10, 2013

(51) Int. Cl. G06Q 40/06

(52) U.S. Cl. CPC G06Q 40/06
USPC 705/36 R

(57) ABSTRACT

Techniques for passive, visualized monitoring of market data using visuals are described and involve receiving by one or more computers a data stream of current market values for the financial item, applying the data stream to a rules engine to determine a change value and using by the computers the determined change value to retrieve an image according to a selected graphical representation of a financial item, with the change value corresponding to a defined status level for the financial item.

### BACKGROUND

This invention relates to market monitoring and more particularly to conveying market information to users.

Real-time market monitoring can involve collection of enormous amounts of data for characterizing how a market is performing. One way to characterize markets is with a stock ticker that displays in text, a stock ticker symbol (typically 1 to 4 letters that represents the entity associated with a security), a price, price change and volume. Another type of stock ticker is a logo ticker that uses an entity's logo in lieu of the stock ticker symbol to identify the entity. Tickers are often used to characterize pricing movements in indexes, e.g. the S&P 500 Index®, The Dow Jones Industrial Average®, The NASDAQ 100 Index®, etc.

While real-time monitoring, collecting large amounts of data and stock tickers convey such large amounts of collected data, quick comparisons by an individual to get a sense of trading trends can be inconvenient or complex.

### SUMMARY

Passive, visualized monitoring of market data using visuals provides a mechanism to monitor the market without seeing numbers. Embodiments can be implemented as screen savers, or on displays in common areas. The images can be displayed as “art” that conveys an alternate monitoring or a “right brain” view of the market. Left-brain/right-brain dominance is a theory in which each side of the brain controls different types of thinking Individuals may prefer one type of thinking over the other. A “left-brained” individual is often said to be more logical, whereas a “right-brained” individual is said to be more intuitive. The techniques discussed herein would tend to be more suitable for “right-brained” individuals but could be used by “left-brained” individuals also.

According to an aspect, a method includes receiving by the one or more computers a data stream of current market values for the financial item, applying by the one or more computers the data stream to a rules engine to determine a change value corresponding to a change between a current value of the financial item and historical value, and using by the one or more computers the determined change value to retrieve an image according to a selected graphical representation of a financial item, with the change value corresponding to a defined status level for the financial item.

According to an additional aspect, a computer program product tangibly stored on a computer readable storage device includes instructions for causing a processor to receive a data stream of current market values for the financial item, apply the data stream to a rules engine to determine a change value corresponding to a change between a current value of the financial item and historical value and use the determined change value to retrieve an image according to a selected graphical representation of a financial item, with the change value corresponding to a defined status level for the financial item.

According to an additional aspect, an apparatus includes a processor, memory coupled to the processor, and a computer readable storage device storing a computer program product that includes instructions for causing the processor to receive a data stream of current market values for the financial item, apply the data stream to a rules engine to determine a change value corresponding to a change between a current value of the financial item and historical value and use the determined change value to retrieve an image according to a selected graphical representation of a financial item, with the change value corresponding to a defined status level for the financial item.

The following are some of the embodiments with the scope of the above aspects.

The values of the financial item are price values. A set of threshold price bands is retrieved and a threshold price band corresponding to a current change value in price for the financial item is determine for the current price of the financial item. The image selected is based on the determined threshold band and the retrieved image is rendered on a display. The graphical selection is graphical images of plants, water, clouds, weather that derive appearance from the condition of the market. The graphical representations are pre-defined graphical objects. The graphical representations are user-defined graphical objects. The security is a financial index comprised of plural financial components. The selection of the graphical representation for the index security with the graphical representation being a composite graphic of plural non numeric objects, and with at least some of the non-numeric objects being associated with component securities of the financial index and with the objects deriving their appearance user-defined status levels for the components. The financial item is at least one of a security, a financial index, a commodity contract, an options contract and other financial product traded on a trading venue. The threshold bands are user defined and correspond to percentage changes in price between a current market price for the financial item and a previous closing price for the financial item. The values of the financial item are trading volume values and a set of threshold trading volume bands are retrieved and a threshold trading volume band corresponding to a current change value in trading volume for the financial item is determined for the current trading volume of the financial item. The data stream is a real time data stream.

Advantages of some or all of these aspects include one or more of the following.

Computer driven displays produce depictions that enable users to visually obtain general market information in passive manner through appearance and/or specific graphic, non-text visual images. This provides a mechanism to monitor market activity without the need to see numbers.

The details of one or more embodiments of the invention are set forth in the accompanying drawings and the description below. Other features, objects, and advantages of the invention will be apparent from the description and drawings, and from the claims.

### DESCRIPTION OF DRAWINGS

The accompanied figures are to be used in conjunction with the description below.

FIG. 1 is a block diagram.

FIG. 2 is a flow chart of a setup procedure for a market monitoring process.

FIG. 3 is a flow chart of a market monitoring process.

FIGS. 4, 5A, 5B, 6A, 6B, 7A, 7B, 8 and 9 are exemplary depictions for use in market monitoring.

The details of one or more embodiments of the invention are set forth in the accompanying drawings and the description below. Other features, objects, and advantages of the invention will be apparent from the description and drawings, and from the claims.

### DETAILED DESCRIPTION

Through a computer system that displays for users market information, users can passively monitor market activity through graphic, non-text visual depictions providing a mechanism to monitor market activity without needing to see numbers. The computing system can be any sort of user client device or can be a server computing system that generates or retrieves depictions that are rendered by a display associated with the client device (e.g., personal computer, tablet computer, smart phone) or can be a stand-alone display that receives the generated/retrieved depictions, via the client device and/or server.

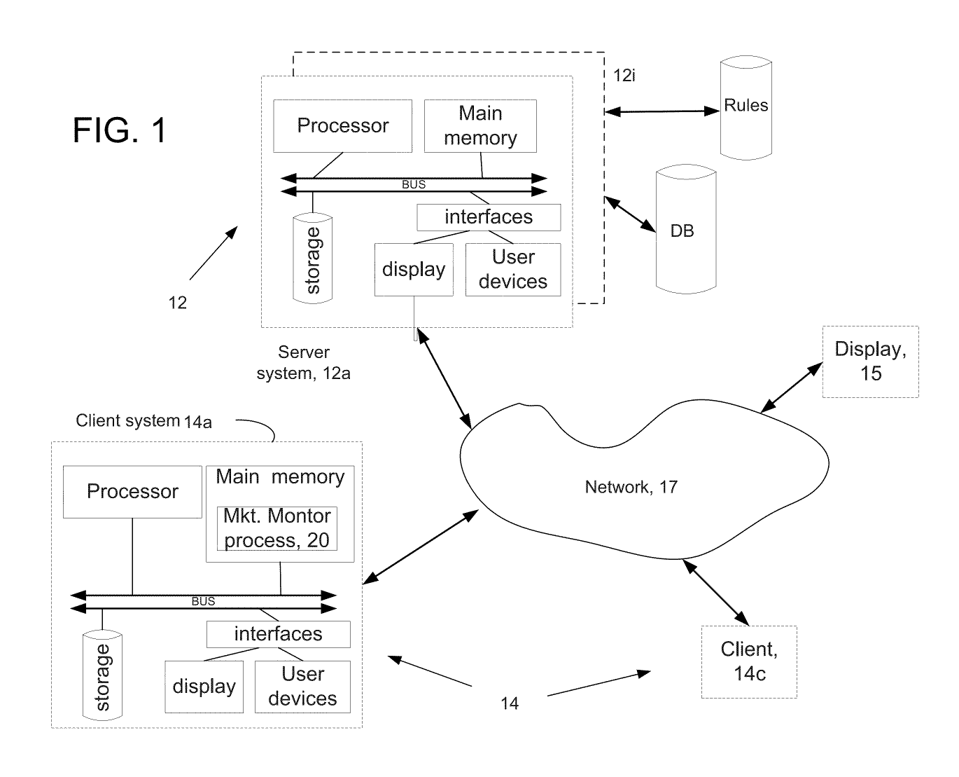

Referring now to FIG. 1, a system 10 includes a server type of computer system 12 comprised of one or more computer systems 12a-12i, one or more client devices, generally 14a-c generally 14, each computer system 12a-12i and client 14 including a processor, memory and computer storage that stores a computer program product that provides a market monitoring process 20 (as illustrated in memory of device 14a).

In some embodiments, the server 12 produces message streams for client devices 14 from real-time financial information that is sent to the servers. When executed, the computer program product configures the server 12 to send the message streams from the server 12 to one or more client devices, generally 14 or displays 15. The message streams include data that renders graphical, non-numeric depictions of market information. In other embodiments, the client devices 14 execute the market monitoring process 20, as illustrated. The client devices 14 receive the real-time financial information directly and produce the depictions.

In some embodiments, the data can be delayed, e.g., up to 20 minutes or so. This is because generally distributors of market data may charge fees for the data, with the fees possibly tied to the age of the data. Real-time market data, e.g., be less milliseconds, or seconds old may command pricing that would not be practical for all users. Thus, in some instances real-time data may not be used, but instead the data would be delayed. Whether real-time or delayed data are used would still be within the scope of the embodiments discussed herein.

The client devices 14 and/or server 12 of the system 10 can access a database that stores historical information and/or user preferences, and graphics. A rules engine that executes on the server 12 and/or the client devices 12 retrieves the user preferences and receives the real-time financial information as well as retrieves historical financial information, e.g., from the database or the like to execute the market monitoring process 20.

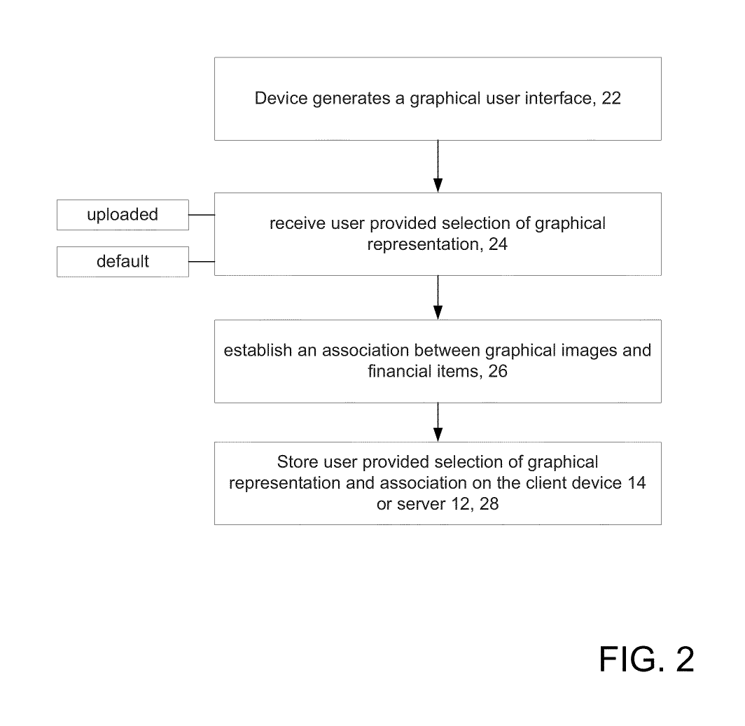

Referring now to FIG. 2, the market monitoring process 20 generates 22 a graphical user interface where uses can select representations for various financial items through, e.g., the client device 14. The user provided selection 24 of a graphical representation for one or more financial items is either stored on the client device 14 or server 12.

The graphical representation can be of various, non-numeric types including plants, water scenes, clouds, weather, shapes and other non-numeric images. These images will derive their appearance from the condition of the market, as will be discussed below. In some embodiments the graphical representations for the one or more financial items are a series of images that are morphed in appearance changing their appearance with changes in the market. These images vary in appearance according to the status of the market. In other embodiments, the images are paired meaning one type of image is used for good “up markets,” the other for bad “down markets.”

Users can select various images to represent various financial items of interest to the users or can upload their own images. Users establish an association 26 between graphical images and financial items. For example, a financial item can be a security index, e.g., the S&P 500 index. A single plant could represent the entire index or multiple plants within an image could represent some or all of the components of the S&P 500 index. That is, while the S&P 500 index has 500 component securities, all or fewer than all of the components can be represented in the graphical image by using plural plants in the graphic image to correspond to plural ones of the components of the index, the graphical representation would thus be a composite graphic of plural non numeric items and with at least some of the non-numeric objects associated with component securities of the financial index. These items will derive their appearance according to market performance mapped to user-defined status levels for the components. In other embodiments, the size of the plants could be used to represent market capitalization of components of the index.

However, for a single financial item, e.g., a security representing a publically traded company or a security representing a traded index, e.g., an ETF such as SPDR (S&P depository receipt) a single item depicted in the graphic could be used. However, in other embodiments depictions can include more general scenes such as clouds, water, etc. with appearance determined according market conditions. The user-provided selection and associations are stored 28 on the user device 14 and/or server 12.

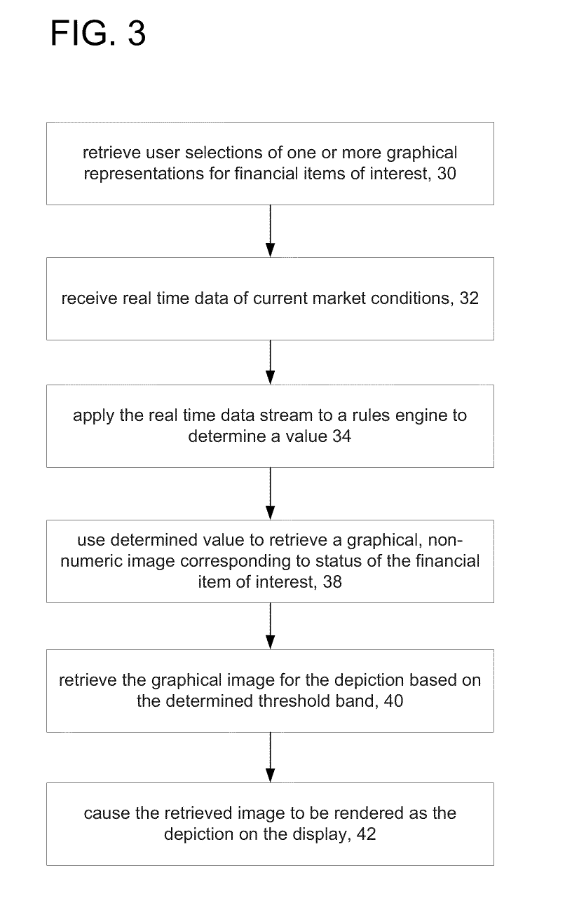

Referring now to FIG. 3, the market monitoring process 20 retrieves 30 user selections of one or more graphical representations for those financial items of interest to the user, once the user preferences are set up. The market monitoring process 20 periodically, e.g., at regular intervals or continuously, receives 32 real time data of current market conditions including information such as trading prices and/or volume about the financial item. The market monitoring process 20 applies 34 the real time data stream to a rules engine to determine a value 36 that corresponds to a current price of the financial item against a reference price. The determined value is mapped into or correlated to one of a plurality of defined bands or levels of interest pertaining to the financial item. These levels are either user defined or system defined. The levels are percentage changes in the current value of the financial item against the reference, typically the prior closing price of the financial item.

Once this value is mapped to one of the defined bands, the market monitoring process 20 uses the determined value to retrieve 38 a graphical, non-numeric image corresponding to the mapped band. The mapping of determined values into the defined bands is performed by the market monitoring process 20 retrieving the set of threshold bands and determining which threshold band contains the value that in this example represents a current change in price against the reference for the financial item. The market monitoring process 20 thus retrieves 40 the graphical image for the depiction based on the determined threshold band and causes 42 the retrieved image to be rendered as the depiction on the display either associated with the server 12, a client device 14 or a stand-alone display fed from the server 12.

The financial items can be of various types of items represented publically traded financial products such as a security (e.g., stock in publically traded companies), a financial index, a commodity contract, an options contract, a commodities index, as well as and other financial products traded on a trading venue. Financial indexes are comprised of plural financial components.

Threshold Bands

When the market for a financial item goes up or down the market monitoring process 20 renders that movement in a non-numeric visual depiction. The user will have the option to set a number of threshold bands and percentage range values for threshold bands.

Table I below shows exemplary percentage bands for changes that would be typical for a market index. In this example there are nine different states:

1. over +1.5%
2. +1.01-1.5%
3. +0.51-1.0%
4. +0.01-0.05%
5. neutral market less than 0.01% change +/−
6. −0.01-0.05%
7. −0.51-1.0%
8. −1.01-1.5%
9. over −1.5%

The user could decide to only see major changes. In the system preferences the user has the option to enter their own percentage changes. For example just 3 states:

| | |
|---|---|
| 1. | Really good - anything up over 2% |
| 2. | Really bad - anything down 2% |
| 3. | Marginal changes - in between +2% and −2% |

Accordingly any number of percent ranges and values of the percent ranges could be used depending on the granularity in monitored pricing changes desired by the user.

The threshold bands are user-defined or system-defined and correspond to percentage changes in price between a current market price for the financial item and a previous closing price for the financial item. In addition, the bands could be based on relative volatility of the financial item with those financial items having relatively high price volatility (large intra-day price swings) having larger bands than those financial item with relatively low price volatility.

The market monitoring process 20 uses representations for the various financial items, where the graphical representations are graphics of a non numeric object or composite graphics of plural non numeric objects. For financial items composed of plural components at least some of the non-numeric objects can be associated with the component of the financial item with the objects deriving their appearance according to the determined levels for the components.

For mapping the user would, e.g., take the number of percent ranges that the user defined and associate a particular image to each range. Thus in the example above that tracks only major changes, the user enter an identifier for a particular image. For example for the three states:

| | | |
|---|---|---|
| 1. | Really good - anything up over 2% | Image 4 |
| 2. | Really bad - anything down 2% | Image 17 |
| 3. | Marginal changes - in between +2% and −2% | Image 10 |

It is understood that the images mentioned above are illustrative, arbitrarily referenced for the above discussion.

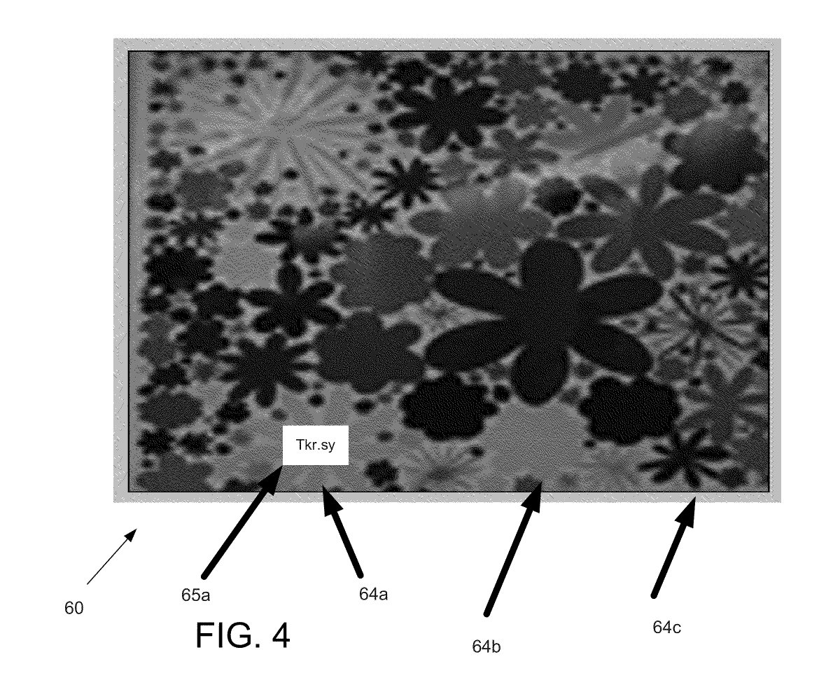

Referring now to FIGS. 4,5A, 5B, 6A, 6B, exemplary graphical image types are shown. These images can be of anything such as plants, water, clouds, weather, or other non-numeric calculated values. The appearance of items in the images, e.g., their health is derived from the condition of the market for the financial item that is associated with the image.

In FIG. 4, a display device 60 (a monitor hung on a wall) depicts a composite image, as shown. This composite image is comprised of plural depictions of shaped objects, i.e. stylized “flowers.” In some embodiments the depictions of these flowers can be generally representative of trading in a security index. That is, the composite image is selected based on the value of the index. Thus, upbeat images can be used for up markets and downbeat images can be used to represent down markets. The individual depictions of the flowers in the images are not assigned any significance.

In other embodiments of FIG. 4, each of these “flowers”, e.g., 64a-64c can be representative of components of, e.g., the security index. In FIG. 4, these “flowers” have various shapes and sizes that in some embodiments can be indicative of sector and relative market capitalization of the individual components, whereas in other embodiments can be representative of relative price movements in the respective components. In still other embodiments the individual images can be labeled with an identifier 65a, e.g., a security ticker symbol “Tkr sy” as shown or security name.

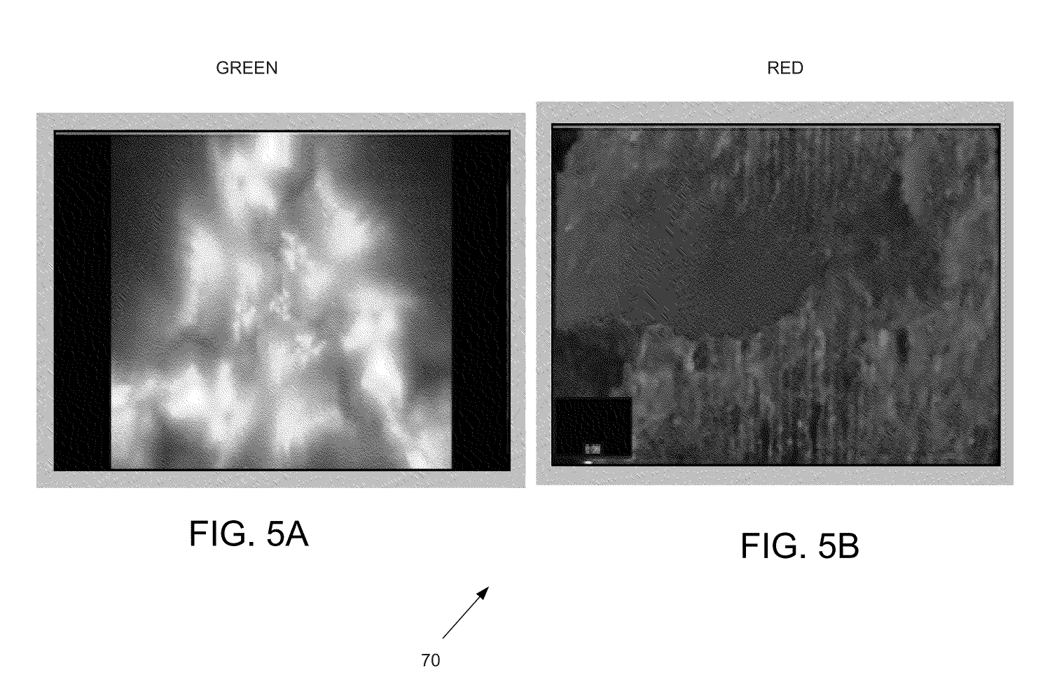

In FIGS. 5A, 5B, a display 70 device depicts either one of the two images as shown. These images are depictions of a flourish of color with one (FIG. 5A) being green and being user defined or system defined as an up-market for an index or security, whereas (FIG. 5B) being a flourish of red and being either user defined or system defined as a down market for a particular user defined or system defined financial item. Note that unlike the embodiment of FIG. 4, components of, e.g., a security index are not individually represented in either FIG. 5A or FIG. 5B.

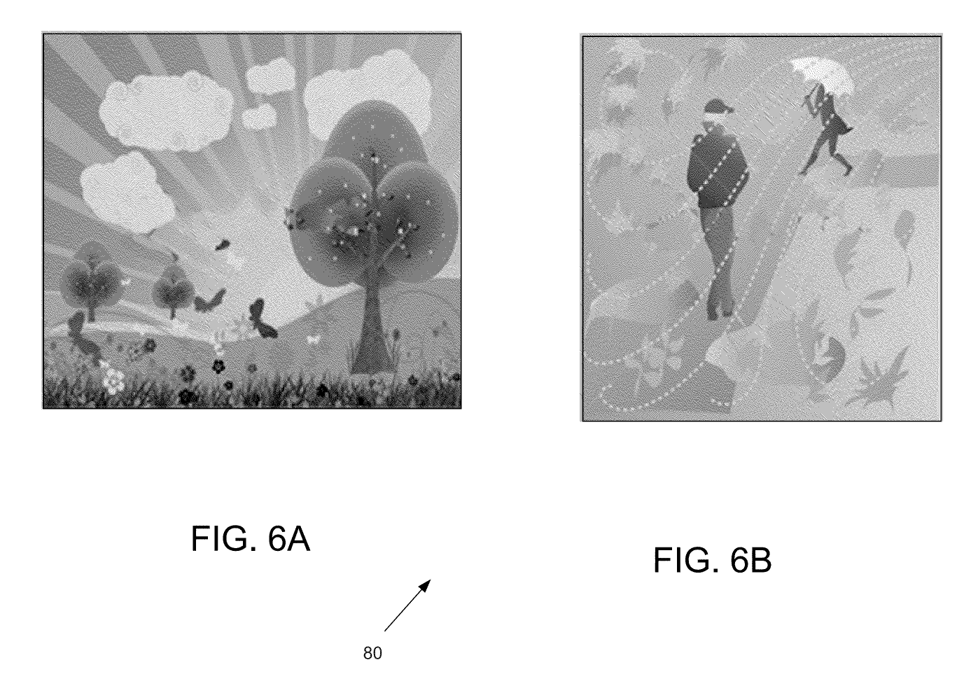

In FIGS. 6A, 6B, a display device 80 depicts either one of the two images as shown. These images are depictions of a pictorial scenes with one (FIG. 6A) being a generally happy scene and being user defined or system defined as an up-market for an index or security, whereas (FIG. 6B) being a generally sad scene being user defined or system defined as a down market for an index or security. Note that unlike the embodiment of FIG. 4, components of, e.g., a security index are not individually represented in either FIG. 6A or FIG. 6B.

As shown in the examples above, visual representations come in various forms. The visual representations can be pre-rendered objects such as a picture or an animation or can be renders as Flash® (Adobe, Inc.) files. The application can be pre-loaded with a set of pre-rendered objects set as default based on market conditions and in some embodiments, the user through system preference setup can add their own images and associate the images with certain market conditions. Any combination of images associated for the same market condition can be combined on the screen.

Dynamic renderings can be produced using an algorithm. An example of a dynamic rendering algorithm would be an algorithm used in media players to visualize music. The user can select visualizations from a number of predefined visual algorithms. Those images produced are typically abstract and involve fractals or oscilloscopic effects. Colors and direction are used as key indicators for market conditions.

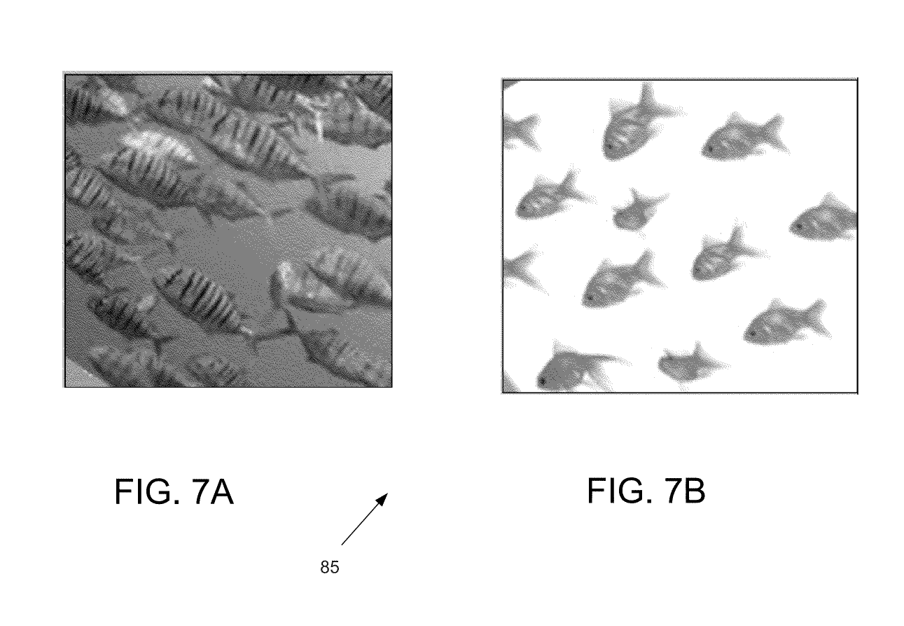

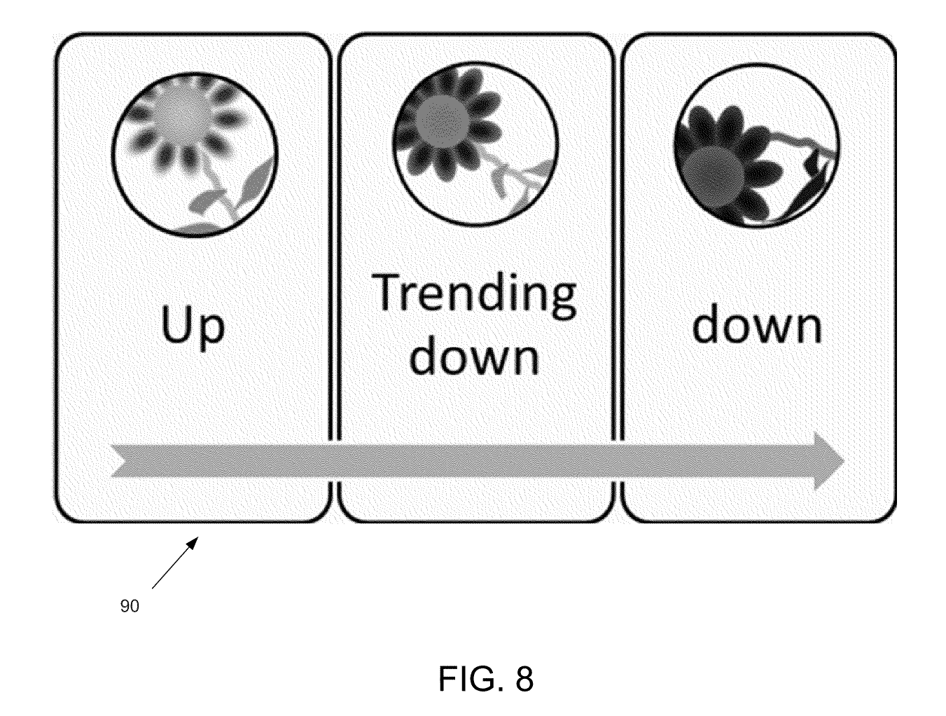

The representations can be stored as objects in a database and are called by the market monitor process 20 when predefined market conditions are met. The database would be set up to use unique identifiers for each object. The objects would be mapped to percentage changes, called and shown when that condition is met. Transition type objects can also be stored and called when the market moves, as depicted in FIGS. 7 and 8.

FIG. 7 shows a display 85 rendering of fish in a green color (up market) whereas FIG. 7B shows fish rendered in red (down market). FIGS. 8A-8C shows a display 90 rendering a flower, where for an up market the flower is depicted as a bright colored, upright flower and as the market trends down, the colors of the flower change to darker colors as the flower starts drooping.

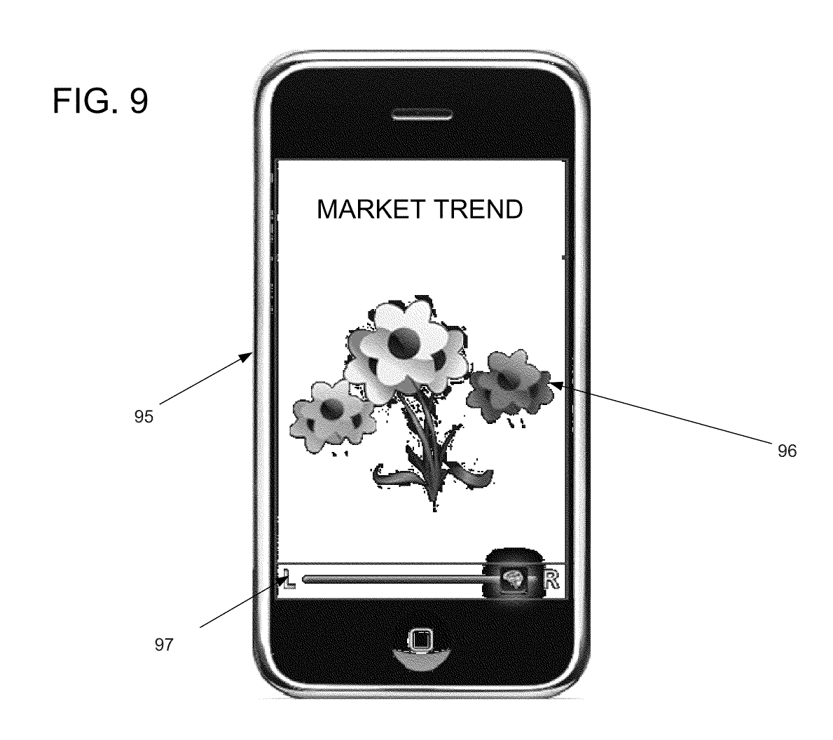

Referring now to FIG. 9, smart-phone 95 (an example of a client device 14 FIG. 1) is shown displaying on the display portion of the phone an alternative arrangement, e.g., produced by a smart phone application executing on the smart phone. In this application the applicant renders a depiction 96 that includes a slider 97 that has left, right and center positions. In the right position (R) images of the current market condition for the monitored security are shown, whereas in the left position (R) graphs and/or charts or numeric values (not shown) for the current market condition for the monitored security is/are depicted, and in the center position graphs and/or charts or numeric values (not shown) are depicted over the images. The user can slide between image, image/numbers or number/chart depictions.

The server can be any of a variety of computing devices capable of receiving information, such as a server, a distributed computing system, a desktop computer, a laptop, a cell phone, a rack-mounted server, and so forth. Server may be a single server or a group of servers that are at a same location or at different locations.

Server can receive information from client devices via interfaces. Interfaces can be any type of interface capable of receiving information over a network, such as an Ethernet interface, a wireless networking interface, a fiber-optic networking interface, a modem, and so forth. Server also includes a processor and memory. A bus system (not shown), including, for example, an information bus and a motherboard, can be used to establish and to control information communication between the components of server.

Processor may include one or more microprocessors. Generally, processor may include any appropriate processor and/or logic configured for receiving and storing information, and of communicating over a network (not shown). Memory can include a hard drive and a random access memory storage device, such as a dynamic random access memory, machine-readable media, or other types of non-transitory machine-readable storage devices.

Components also include storage device, which is configured to store information, map, map templates, rules information for the rules, software for the rules engine, etc.

Embodiments can be implemented in digital electronic circuitry, or in computer hardware, firmware, software, or in combinations thereof. Apparatus can be implemented in a computer program product tangibly embodied or stored in a machine-readable storage device and/or machine readable media for execution by a programmable processor; and method actions can be performed by a programmable processor executing a program of instructions to perform functions and operations by operating on input information and generating output. Aspects can be implemented advantageously in one or more computer programs that are executable on a programmable system including at least one programmable processor coupled to receive information and instructions from, and to transmit information and instructions to, a information storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and information from a read-only memory and/or a random access memory. Generally, a computer will include one or more mass storage devices for storing information files; such devices include magnetic disks, such as internal hard disks and removable disks; magneto-optical disks; and optical disks as well as solid state disk drives. Storage devices suitable for tangibly embodying computer program instructions and information include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. For example, while discussion has focused on price changes, the principals above could be applied to volume changes to depict market activity. In such a use, the values of the financial item that are used in calculations would be trading volume values, and the set of threshold bands would be trading volume bands, e.g., number of shares traded over a period, e.g., a day an week, an hour, etc. The market monitoring process would determine for the current volume of trading in the financial item a threshold trading volume band that corresponds to a current change value in trading volume for the financial item and would select an image associated with the determined trading volume band. Accordingly, other embodiments are within the scope of the following claims.

1. A method of conveying financial market data, the method, comprising:
receiving by the one or more computers a data stream of current market values for a financial item;
applying by the one or more computers the data stream to a rules engine to determine a change value corresponding to a change between a current value of the financial item and a historical value;
mapping by the one or more computers the determined change value to a predefined trading status level for the financial item; and
retrieving by the one or more computers an image, with the image selected according to the trading status level for the financial item, the selected image being a graphical representation having an appearance in correspondence with the trade status of the financial item.

2. The method of claim 1, wherein the values of the financial item are price values and applying further comprises:
retrieving a set of threshold price bands; and
determining for the current price of the financial item a threshold price band corresponding to a current change value in price for the financial item.

3. The method of claim 2 further comprising:
retrieving the image based on the determined threshold band;
causing the retrieved image to be rendered on a display.

4. The method of claim 1 wherein the graphical selection is graphical images of plants, water, clouds, weather that derive their health and appearance from the condition of the market.

5. The method of claim 1 wherein the graphical representations are pre-defined graphical objects.

6. The method of claim 1 wherein the graphical representations are user-defined graphical objects.

7. The method of claim 1 wherein the financial item is a financial security index comprised of plural financial components.

8. The method of claim 7, further comprising:
receiving the selection of the graphical representation for the financial index security with the graphical representation being a composite graphic of plural non numeric objects and with at least some of the non-numeric objects being associated with component securities of the financial security index and with the objects deriving their appearance user-defined status levels for the components.

9. The method of claim 1 wherein the financial item is at least one of a stock security, a financial index, a commodity contract, an options contract, and exchange traded fund and a financial product traded on a trading venue.

10. The method of claim 1 wherein the threshold bands are user defined and correspond to percentage changes in price between a current market price for the financial item and a previous closing price for the financial item.

11. The method of claim 1, wherein the values of the financial item are trading volume values and applying further comprises:
retrieving a set of threshold trading volume bands; and
determining for the current trading volume of the financial item a threshold trading volume band corresponding to a current change value in trading volume for the financial item.

12. The method of claim 1 wherein the data stream is a real time data stream.

13. A computer program product tangibly stored on a computer readable hardware storage device, the computer program product for conveying market activity data, the computer program product comprising instructions for causing a processor to:
receive a data stream of current market values for the financial item;
apply the data stream to a rules engine to determine a change value corresponding to a change between a current value of the financial item and historical value;
map the determined change value to a predefined trading status level for the financial item; and
retrieve an image with the image selected according to the trading status level for the financial item, the selected image being a graphical representation having an appearance in correspondence with the trade status of the financial item.

14. The computer program product of claim 13 wherein the values of the financial item are price values and instructions to apply further comprise instructions to:
retrieve a set of threshold price bands; and
determine for the current price of the financial item a threshold price band corresponding to a current change value in price for the financial item.

15. The computer program product of claim 14 further comprising instructions to:
retrieve the image based on the determined threshold band;
cause the retrieved image to be rendered on a display.

16. The computer program product of claim 13 wherein the graphical selection is graphical images of plants, water, clouds, weather that derive their health and appearance from the condition of the market.

17. The computer program product of claim 13 wherein the financial item is a financial security index comprised of plural financial components and the instructions further comprise instructions to:
receive the selection of the graphical representation for the financial security index with the graphical representation being a composite graphic of plural non numeric objects and with at least some of the non-numeric objects being associated with component securities of the financial security index and with the objects deriving their appearance user-defined status levels for the components.

18. The computer program product of claim 13 wherein the financial security is at least one of a stock security, a financial index, a commodity contract, an options contract and exchange traded fund and a financial product traded on a trading venue.

19. The computer program product of claim 13 wherein the threshold bands are user defined and correspond to percentage changes in price between a current market price for the financial item and a previous closing price for the financial item.

20. The computer program product of claim 13 wherein the values of the financial item are trading volume values and instructions to apply comprise instructions to:
retrieve a set of threshold trading volume bands; and
determine for the current trading volume of the financial item a threshold trading volume band corresponding to a current change value in trading volume for the financial item.

21. The computer program product of claim 13 wherein the data stream is a real time data stream.

22. An apparatus comprising:
a processor;
memory coupled to the processor;
a computer readable storage device storing a computer program product, the computer program product comprising instructions for causing the processor to:
receive a data stream of current market values for the financial item;
apply the data stream to a rules engine to determine a change value corresponding to a change between a current value of the financial item and historical value;
map the determined change value to a predefined trading status level for the financial item; and
retrieve an image with the image selected according to the trading status level for the financial item, the selected image being a graphical representation having an appearance in correspondence with the trade status of the financial item.

23. The apparatus of claim 22 wherein the values of the financial item are price values and instructions to apply further comprise instructions to:
retrieve a set of threshold price bands; and
determine for the current price of the financial item a threshold price band corresponding to a current change value in price for the financial item.

24. The apparatus of claim 23 further comprising instructions to:
retrieve the image based on the determined threshold band;
cause the retrieved image to be rendered on a display.

25. The apparatus of claim 22 wherein the graphical selection is graphical images of plants, water, clouds, weather that derive their health and appearance from the condition of the market.

26. The apparatus of claim 22 wherein the financial item is a financial index comprised of plural financial components and the instructions further comprise instructions to:
receive the selection of the graphical representation for the financial index security with the graphical representation being a composite graphic of plural non numeric objects and with at least some of the non-numeric objects being associated with component securities of the financial index security and with the objects deriving their appearance user-defined status levels for the components.

27. The apparatus of claim 22 wherein the financial item is at least one of a stock security, a financial index, a commodity contract, an options contract, an exchange traded fund, and a financial product traded on a trading venue.

28. The apparatus of claim 22 wherein the threshold bands are user defined and correspond to percentage changes in price between a current market price for the financial item and a previous closing price for the financial item.

29. The apparatus of claim 22 wherein the values of the financial item are trading volume values and instructions to apply comprise instructions to:
retrieve a set of threshold trading volume bands; and
determine for the current trading volume of the financial item a threshold trading volume band corresponding to a current change value in trading volume for the financial item.

30. The apparatus of claim 22 wherein the data stream is a real time data stream.

31. The method of claim 1 further comprising:
periodically performing the steps of receiving, applying and retrieving to update the selected graphical representation to have the appearance of the selected graphical representation change periodically according to changes in the determined change value.

32. The method of claim 1, wherein the financial item is a financial security index and the method further comprises:
periodically performing the steps of receiving, applying and retrieving to update the selected graphical representation to have the appearance of non-numeric objects that represent component securities of the financial security index in the selected graphical representation change periodically according to changes in determined change values of component securities of the financial security index.

33. The computer program product of claim 13 further comprising instructions to:
periodically execute the instructions to receive, apply and retrieve to update the selected graphical representation to have the appearance of the selected graphical representation change periodically according to changes in the determined change value.

34. The computer program product of claim 13 further comprising instructions to:
periodically execute the instructions to receive, apply and retrieve to update the selected graphical representation to have the appearance of non-numeric objects that represent component securities of the financial security index in the selected graphical representation change periodically according to changes in determined change values of component securities of the financial security index.

35. The apparatus of claim 22 wherein the computer program product further comprises instructions to:
periodically execute the instructions to receive, apply and retrieve to update the selected graphical representation to have the appearance of the selected graphical representation change periodically according to changes in the determined change value.

36. The apparatus of claim 22 wherein the computer program product further comprises instructions to:
periodically execute the instructions to receive, apply and retrieve to update the selected graphical representation to have the appearance of non-numeric objects that represent component securities of the financial security index in the selected graphical representation change periodically according to changes in determined change values of component securities of the financial security index.
